(19) United States
(12) Patent Application Publication
(10) Pub. No.: US 2005/0054310 A1
(43) Pub. Date: Mar. 10, 2005

(54) Heterodyne system

(76) Inventor: Stephen T. Sparks, Santa Rosa, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/659,912

(22) Filed: Sep. 10, 2003

(51) Int. Cl. H04B 1/18

(52) U.S. Cl. 455/182.1

(57) ABSTRACT

A heterodyne system provides a first signal and a second signal in response to a received drive signal, wherein the frequency of the first signal divided by the frequency of the second signal is an integer ratio. A mixer receives the first signal and the second signal and provides a series of mixing products. Spurious signals generated by the mixer are offset from a designated one of the mixing products by integer multiples of the frequency of the second signal divided by the denominator of the integer ratio when the integer ratio is reduced to its lowest terms.

### BACKGROUND OF THE INVENTION

Heterodyning, or mixing, is used to extend operating frequency ranges of many types of signal sources. For example, a tuneable signal S1 at frequency F1 within a signal source can be translated to produce a desired signal S3 having frequency F3=F1±F2 when mixed with a fixed frequency signal S2 provided by another source at frequency F2 as shown in FIG. 1A. However, inherent nonlinearities in the mixing cause unwanted spurious signals, or “spurs” Ss in addition to the desired signal S3. These spurs Ss (shown in FIG. 1B), which typically occur at frequencies Fs=NF1±MF2 (N, M integers), are especially problematic when they “cross” the signal S3, or when the combinations of frequencies F1, F2, and integers N, M cause the frequencies Fs of the spurs to lie close to the frequency F3 of the signal S3. Crossing spurs, which move upward from a frequency below the frequency F3 or downward from a frequency above the frequency F3 as the frequency of the signal S1 is tuned, can actually “cross”, or move through, the frequency F3 of the signal S3. Being close to the signal S3, these spurs Ss can introduce errors when the signal source is used to test adjacent-channel selectivity of a receiver. When the signal source is used as a local oscillator of a spectrum analyzer, the spurs can cause on-screen false signals or spurious responses that may be difficult to distinguish from the signals being analyzed by the spectrum analyzer.

While many signal sources include a filter BPF to remove spurs Ss that are sufficiently offset in frequency from the signal S3, close-in spurs and crossing spurs that lie inside the passband PB of the BPF are not removed (FIG. 1B). Accordingly, various schemes have been used to minimize the spurs Ss that lie close to the frequency F3 of the signal S3.

A first mixing scheme involves the signal S2 having a multitude of fixed frequencies F2, so that for desired signals S3, a combination of the signals S1 and S2 is available that does not produce spurs that are strong close to the frequency F3 of the signal S3. Spurs Ss resulting from combinations of signals S1 and S2 that have high values of M and N, for example, are weaker and have lower magnitude than spurs that result from lower values of M and N. While this scheme may reduce the levels of close-in spurs and crossing spurs, it relies on the signal S2 having multiple frequencies F2, which may add to the cost or complexity of the signal source employing the mixing scheme. Another approach reduces the effect of spur-generating nonlinearities by lowering the level of the signal S1 driving a linear port of a mixer MXR that mixes the signals S1, S2. While this can lower the levels of the close-in spurs and crossing spurs, it typically degrades the signal-to-noise ratio of the signal source within which the mixer is included.

In view of the above shortcomings, there is a need for mixing scheme that reduces close-in spurs and crossing spurs in a signal source.

### SUMMARY OF THE INVENTION

Embodiments of the present invention are directed toward a heterodyne, or mixing, system and method that avoid generating close-in spurs and crossing spurs.

### BRIEF DESCRIPTION OF THE DRAWINGS

FIGS. 1A-1B show a prior art mixing scheme.

FIGS. 2A-2C show block diagrams of a heterodyne system according to embodiments of the present invention.

FIG. 3 shows exemplary signals within the heterodyne system according to the embodiments of the present invention.

FIG. 4 is a flow diagram of a heterodyne method according to alternative embodiments of the present invention.

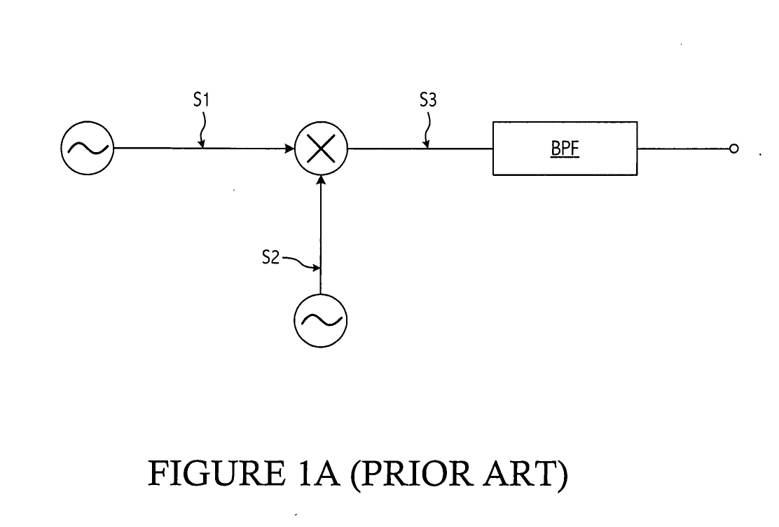

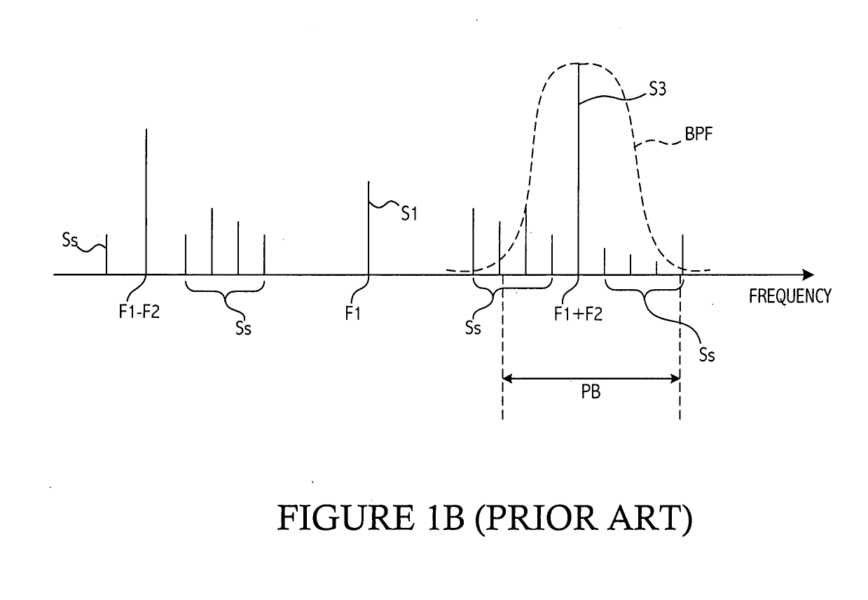

### DETAILED DESCRIPTION OF THE EMBODIMENTS

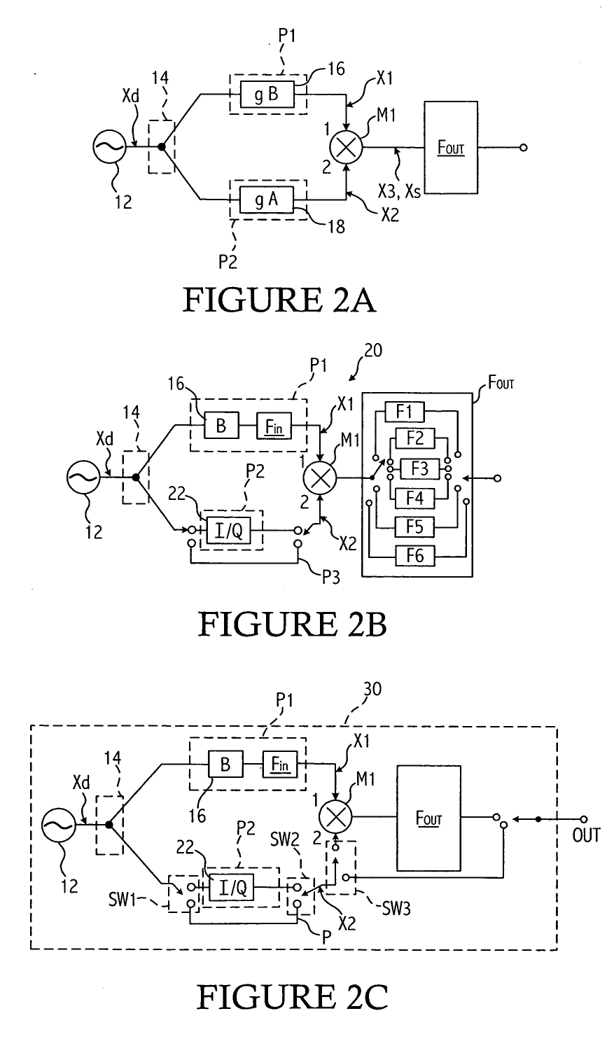

FIGS. 2A-2C show heterodyne systems according to embodiments of the present invention. The heterodyne system 10 in FIG. 2A includes a signal path P1 and a signal path P2, each receiving a drive signal Xd. In the example shown, the drive signal Xd is provided by a YIG tuned oscillator (YTO) that is tuneable over a frequency range of approximately 3-20 GHz. However, the drive signal Xd can be provided by any suitable source 12, either fixed in frequency or tuneable over a range of frequencies. When the heterodyne system 10 operates at high frequencies, such as RF or microwave frequencies, impedance matching and isolation between the first signal path, the second signal path and the source can be provided by a power splitter, coupler or other suitable network 14 interposed between the source 12 and the signal paths P1, P2.

The signal path P1 provides a signal X1 in response to the received drive signal Xd, whereas the signal path P2 provides a signal X2 in response to the received drive signal Xd. One or both of the signal paths P1, P2 include frequency scalers 16, 18. The frequency scalars 16, 18, modify, or scale, the frequency fd of the drive signal Xd within one or both of the corresponding signal paths P1, P2 by factors g*B, g*A, respectively, where A and B are integers and where g has any predesignated value. The frequency scaling causes the ratio of the frequency f1 of the signal X1 and the frequency f2 of the signal X2 to be an integer ratio, that is, a ratio of integers. Accordingly, the frequency scaling results in the frequency relationship f1=f2(B/A) between the signals X1, X2, where the fraction (B/A), hereafter represents the integer ratio (g*B)/(g*A) reduced to lowest terms. Typically, the frequency scalers 16, 18 are implemented using frequency multipliers and/or frequency dividers in one or both of the signal paths P1, P2.

The signal path P1 and the signal path P2 are coupled to a mixer M1, so that the signal X1 is provided to a first port 1 of the mixer M1 and the second signal X2 is provided to a second port 2 of the mixer M1. In high frequency applications, the mixer M1 is typically a diode ring, or other type of double balanced mixer. However, a variety of types of mixers M1 are suitable for mixing the signals X1, X2.

In response to the signals X1, X2 at the ports 1, 2, the mixer M1 generates a series of mixing products, including a desired signal X3 at frequency f3, where the frequency f3=f1±f2. When the signal X3 has frequency f3=f1+f2, an image X3′ of the signal X3 is typically present at frequency f1−f2, whereas when the signal X3 has frequency f3=f1−f2, an image X3′ of the signal X3 is typically present at frequency f1+f2. The series of mixing products also includes spurious signals, or spurs Xs, resulting from the inherent nonlinearities of the mixer M1, at frequencies fs=Nf2±Mf1, where N, M are integers. The integer ratio relationship between the frequencies f1, f2 of the signals X1, X2 results in the following frequency relationships for the spur frequencies: fs=Nf2±MB/A(f2)=(J/A)f2, where J=NA±MB, an integer. While a spur Xs may not occur at frequencies fs for all values of J, there is an integer J for each of the spurs Xs that does occur.

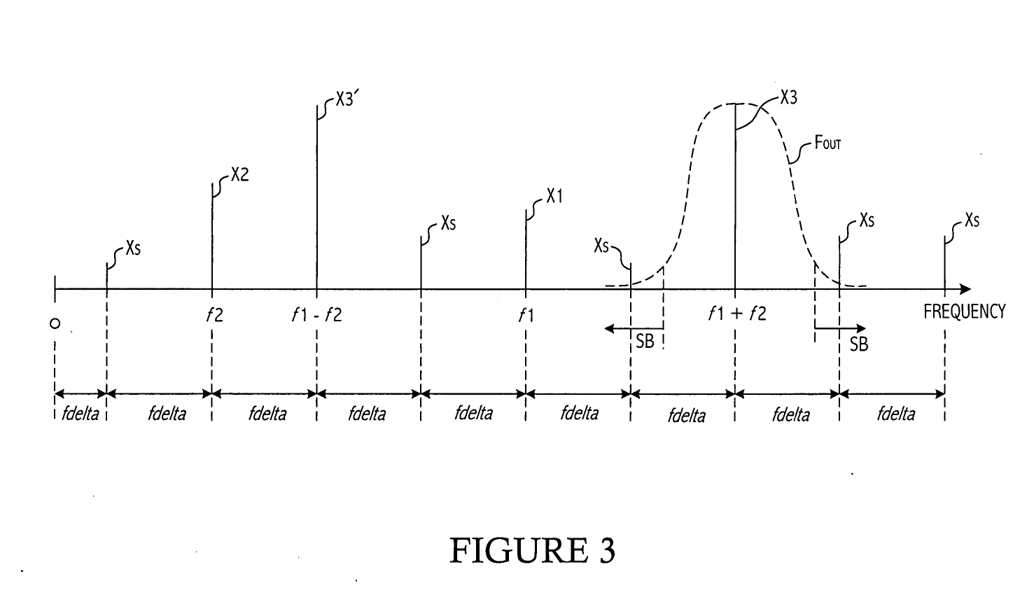

From the above relationships, the frequency relationship between the signal X3 and the spurs Xs can be established. In particular, the frequency f3 of the signal X3 is expressed by the relationship:
f3=f1±f2=(B/A±1)f2=(K/A)f2, where K is an integer,
whereas the frequencies fs of the spurs Xs can be expressed by the relationship:
fs=(J/A)f2+f3−(K/A)f2=f3+((J−K)/A)f2=f3+(L/A)f2, where L is an integer.
Thus, the spurs Xs are either coincident with the signal X3 (L=0), or the spurs Xs are offset in frequency from the desired signal X3 by the amount (L/A)f2. With the integer ratio B/A representing the integer ratio of the frequencies f1, f2 of the signals X1, X2 respectively, reduced to lowest terms, the offset spur Xs closest to the desired signal X3 is at a frequency offset f2/A (L=1). With the signal X3 having frequency f3=f1+f2, the offset spurs Xs are separated in frequency by frequency spacing fdelta=f3/(B+A)=f2/A (as shown in FIG. 3). With the signal X3 having frequency f3=f1−f2, the offset spurs Xs are separated in frequency by frequency spacing fdelta=f3/(B−A)=f2/A.

The frequency offsets (L/A)f2 of the spurs Xs (shown in FIG. 3) enable the non-coincident spurs to be filtered to improve the spectral purity of the signal X3 provided by the mixer M1. In this example, an optionally included filter F_{OUT}, which may include a single filter, multiple filters, or bank of switchable filters, is shown cascaded with the mixer M1. The filter F_{OUT} selects the desired mixing product, the signal X3, from a series of mixing products provided by the mixer M1 that includes the signal X3, images X3′ of the signal X3, and the spurs Xs. The image X3′ of the signal X3 and the non-coincident spurs Xs lie in the stopband SB, which is outside the passband of the filter F_{OUT}. The type and characteristics of the filter F_{OUT} typically depends on the range of frequencies f3 of the signal X3 and the performance requirements of the signal source within which the heterodyne system 10 is optionally included.

FIG. 2B shows an exemplary configuration of the heterodyne system 10 shown in FIG. 2A according to an alternative embodiment of the present invention. The frequency path P1 of this heterodyne system 20 includes a frequency scaler 16 that is an integer frequency multiplier. The integer multiplier, implemented using two cascaded frequency doublers (not shown), receives the drive signal Xd in the signal path P1 and multiplies the frequency fd of the drive signal Xd by the multiplier B, which in this example is equal to the integer four. The signal path P2 in this example does not include a frequency scaler 18, which results in the factors g and A each being unity. With the factor A being unity, the spurs Xs lie at frequency offsets from the signal X3 equal to integer multiples of the frequency fd of the drive signal Xd.

An optionally included filter Fin, which may include a single filter, multiple filters, or bank of switchable filters, is shown interposed between the multiplier 16 and the mixer M1 in the signal path P1. The filter Fin selects the 4^{th} harmonic of the drive signal Xd to improve the spectral purity of the signal X1 driving the mixer M1. The type and characteristics of the filter Fin typically depends on the range of frequencies fd of the drive signal Xd, the range of frequencies f2 of the signal X2, the multiplier B provided by the frequency scaler 16, and the performance requirements of the signal source within which the heterodyne system 20 is optionally included.

The signal path P2 is shown with an optionally included modulator 22 for imposing modulation on the signal X2. In this example, the modulator 22 operates over the range of frequencies fd of the drive signal Xd and is an I/Q modulator. However, other types of modulators are alternatively included in the signal path P2. Depending on the through loss of the modulator 22 and the requirements of the signal source within which the heterodyne system 20 is optionally included, a bypass path P3 can be added to the signal path P2 so that an unmodulated signal X2 of sufficiently high level can alternatively be provided to the port 2 of the mixer M1.

The passband of the filter F_{OUT} is sufficiently broad to enable the modulation imposed on the signal X2 and translated by the mixer M1 to the signal X3, to be represented at the output of the filter F_{OUT}. The filter F_{OUT} may include a single filter, multiple filters, or bank of switchable filters cascaded with the mixer M1 to select the signal X3 from the series of mixing products provided by the mixer M1 where, the type and characteristics of the filter F_{OUT} typically depends on the range of frequencies f3 of the signal X3 and the performance requirements of the signal source within which the heterodyne system 20 is optionally included.

In one example, the drive signal Xd spans a range of frequencies fd between 3 and 20 GHz, and the signal X3 provided by the mixer M1 covers a range of frequencies f3 between 20 and 44 GHz. The filter F_{OUT} in this example (shown in FIG. 2B) includes six switchable bandpass filters F1-F6, each covering a portion of the range of frequencies f3 summarized in Table 1.

TABLE 1

| | |
|---|---|
| Filter F1 | Passband 20.0-24 GHz |
| Filter F2 | Passband 24.0-28.5 GHz |
| Filter F3 | Passband 28.5-32.0 GHz |
| Filter F4 | Passband 32.0-36.0 GHz |
| Filter F5 | Passband 36.0-40.0 GHz |
| Filter F6 | Passband 40.0-44.0 GHz |

FIG. 2C shows the heterodyne system of FIG. 2B included as part of a signal source 30 in accordance with an alternative embodiment of the present invention. While the exemplary heterodyne system 20 of FIG. 2B is shown, the heterodyne system 10 of FIG. 2A can also be included in the signal source 30. The signal source 30 in this example includes a switchable bypass path P so that the heterodyne system 30 can be shunted via switches SW1-SW3, and the drive signal Xd can be provided at an output OUT of the signal source 30.

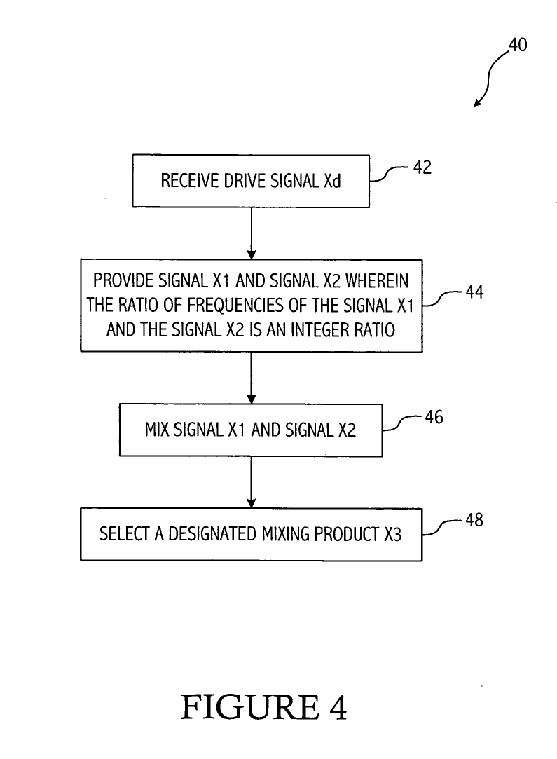

Alternative embodiments of the present invention are directed to a heterodyne method 40 as shown in FIG. 4. In step 42 of the method 40, the drive signal Xd is received. In step 44, the signal X1 and the signal X2 are provided in response to the drive signal Xd, wherein the frequencies f1, f2 of one or both of the signals X1, X2 are, scaled or modified relative to the frequency fd of the drive signal Xd so that the ratio of the frequencies of the signal X1 and the signal X2 is an integer ratio. The signal X1 and the signal X2 are mixed in step 46 to provide a series of mixing products of the signal X1 and the second signal X2. In step 48, a designated one of the mixing products, the signal X3, is selected from the series of mixing products.

While the embodiments of the present invention have been illustrated in detail, it should be apparent that modifications and adaptations to these embodiments may occur to one skilled in the art without departing from the scope of the present invention as set forth in the following claims.

1. A heterodyne system, comprising:
a first signal path receiving a drive signal and providing a first signal in response to the drive signal;
a second signal path receiving the drive signal and providing a second signal in response to the drive signal, at least one of the first signal path and the second signal path scaling the frequency of the drive signal so that the frequency of the first signal divided by the frequency of the second signal is an integer ratio; and
a mixer receiving the first signal and the second signal, providing a series of mixing products of the first signal and the second signal.

2. The heterodyne system of claim 1 wherein the series of mixing products includes a designated signal, and wherein mixing products in the series other than the designated signal are offset in frequency from the designated signal by integer multiples of the frequency of the second signal divided by the denominator of the integer ratio when the integer ratio is reduced to lowest terms.

3. The heterodyne system of claim 1 further comprising at least one filter selecting a designated one of the mixing products in the series.

4. The heterodyne system of claim 2 further comprising at least one filter selecting the designated signal and rejecting mixing products in the series other than the designated signal.

5. The heterodyne system of claim 1 wherein the first signal path includes a frequency multiplier.

6. The heterodyne system of claim 1 wherein the second signal path includes a modulator imposing modulation on the second signal.

7. The heterodyne system of claim 5 wherein the second signal path includes a modulator imposing modulation on the second signal.

8. The heterodyne system of claim 5 wherein the frequency multiplier includes cascaded frequency doublers.

9. The heterodyne system of claim 1 further comprising a source providing the drive signal to the first signal path and the second signal path.

10. The heterodyne system of claim 9 further comprising a switchable bypass path alternatively coupling the designated signal and the drive signal to an output.

11. A heterodyne system, comprising:
a first signal path scaling the frequency of a received drive signal by an integer multiple to provide a first signal;
a second signal path receiving the drive signal and providing a second signal in response to the drive signal; and
a mixer receiving the first signal and the second signal, and providing a series of mixing products of the first signal and the second signal.

12. The heterodyne system of claim 11 wherein the second signal path includes a modulator for imposing modulation on the second signal.

13. The heterodyne system of claim 12 wherein the modulator is an IQ modulator.

14. The heterodyne system of claim 11 further comprising at least one filter selecting a designated mixing product from the series of mixing products.

15. The heterodyne system of claim 14 wherein the at least one filter has a stopband rejecting mixing products in the series that are offset in frequency from the designated mixing product by integer multiples of the frequency of the second signal.

16. The heterodyne system of claim 11 further comprising a source providing the drive signal to the first signal path and the second signal path.

17. A heterodyne method, comprising:
receiving a drive signal;
providing a first signal and a second signal in response to the drive signal, wherein the frequency of the first signal divided by the frequency of the second signal is an integer ratio; and
mixing the first signal and the second signal to provide a series of mixing products of the first signal and the second signal.

18. The heterodyne method of claim 17 wherein the series of mixing products includes a designated signal, and wherein mixing products in the series other than the designated signal are offset in frequency from the designated signal by integer multiples of the frequency of the second signal divided by the denominator of the integer ratio when the integer ratio is reduced to lowest terms.

19. The heterodyne method of claim 17 further comprising selecting a designated one of the mixing products in the series.

20. The heterodyne method of claim 17 further comprising imposing modulation on the second signal.
